(19) United States
(12) Patent Application Publication
(10) Pub. No.: US 2015/0363715 A1
(43) Pub. Date: Dec. 17, 2015

(54) PRODUCTION PLANNING AND CONTROL SYSTEM OF A PRINTING FACILITY AND METHOD FOR THE AUTOMATED PRODUCTION OF A PRINT ORDER

(71) Applicant: manroland web systems GmbH, Augsburg (DE)

(72) Inventors: Franz REISMUELLER, Dasing (DE); Andreas Metzner, Aystetten (DE); Andreas Elchlepp, Aichach (DE); Thomas Zircher, Diedorf (DE)

(73) Assignee: manroland web systems GmbH, Augsburg (DE)

(21) Appl. No.: 14/741,222

(22) Filed: Jun. 16, 2015

(30) Foreign Application Priority Data
Jun. 17, 2014 (DE) 10 2014 108 477.2

(51) Int. Cl. G06Q 10/06; G06Q 10/08; G06F 3/12

(52) U.S. Cl. CPC G06Q 10/0631; G06F 3/1204; G06F 3/1282; G06F 3/1254; G06F 3/1243; G06Q 10/087

(57) ABSTRACT

A device and method for automatically generating a production data set for an order to be printed in a printing facility is disclosed. Job data of an order to be printed and production possibilities of at least one processing device of the printing facility are received at an imposition module. The production data set for the order to be printed is automatically generated by the imposition module based on the job data and the production possibilities.

This application claims the priority of German Patent Document No. DE 10 2014 108 477.2, filed Jun. 17, 2014, the disclosure of which is expressly incorporated by reference herein.

### BACKGROUND AND SUMMARY OF THE INVENTION

The invention relates to a production planning and control system of a printing facility and to a method for the automated production of a print order. The invention, furthermore, relates to a method for automatically generating production data sets taking into account the job data of the order to be printed and the production possibilities of the processing devices of a printing facility.

In print shops, print form variable printing presses such as, for example, digital printing presses are increasingly employed in addition to non-print form variable printing presses such as, for example, offset printing presses or intaglio printing presses, which compared with conventional offset printing are particularly suitable for processing a multitude of changing print orders, e.g., for small print runs. It has transpired that a combination of both methods, i.e., offset and digital printing methods (hybrid printing methods), can bring economic advantages and opens up new possibilities during the printing of products. Accordingly, personalization can be effected, for example, by digital print, while the static contents are printed by offset print.

In order to be able to generate a print order, different information has to be processed. It is already known that print order data are generated by a planning device based on the jobs to be printed and depending on the printing facility that is available. The planning device determines which of the available printing facilities has to process the job provided multiple possibilities are available, which is explained for example in German Patent Document DE 10 2013 102 756.3.

With known methods for generating print orders, the data of the order to be printed, simplified also called job data, for a desired print product are recorded and described by a print planning module. Furthermore, the production possibilities of the components or processing devices involved in the production are recorded.

Based on the data of the job description, it is then checked by a further processing planning module described, for example, in German Patent Document DE 10 2012 103 679 A1, if a further processing device located downstream of the printing press can carry out the order issued by the print planning module. If this is not the case, the order is put on hold until it can be changed or carried out. When the order can be carried out, the content and job data are processed on the appropriate systems and passed on for printing or further processing as required.

The disadvantage with the methods known to date consists in that up to now no further processing-dependent and complete description taking into account the requirements of the automation of a print order can take place, i.e., all information needed to completely describe the print order cannot yet be centrally processed. An experienced user is still required who, based on the user's experience and the knowledge of the further processing device, completes the print order and the imposition instruction or, as mentioned above, modules are used which at least make possible detecting that a print order cannot be processed in a downstream further processing device, thereby stopping the order.

This impossibility of providing a complete description of a print order, i.e., of the production data set, based on all information regarding the printing facility, renders the method susceptible to errors. Furthermore, it is becoming ever more difficult for an operator, because of the increasing complexity of the methods through the use of hybrid printing methods, to remain in control regarding sometimes thousands of possibilities for generating a complete print order.

In order to obtain a completely described print order, incorporation of dynamic data such as, for example, configuration data, personalizations, divisions, hybrid components, taking into account data of methods differing regarding process during the product description and/or incorporation of preferences regarding process or additionally necessary elements which are not part of the actual product, and of further and additionally available data has to be possible preferably in an automated manner. These data are called production possibilities.

Configuration data are, for example, data which describe the production possibilities of a printing press employed. Data of methods differing regarding process during the product description are, for example, the integration of the respective necessary additional information for the printing facilities used such as plate bending with offset printing facilities or additionally needed space for inkjet nozzle cleaning during digital printing. Preferences regarding process are, for example, avoiding known process error sources. Additionally needed elements, which are not part of the actual product, are such as serve, for example, for control purposes, so-called synchronizing signatures or such as serve for other purposes that are important for the production, for example white signatures for separating jobs. In addition, additionally available data, which were not taken into account in an automatic manner in the past are, for example, data of any existing re-processing device, e.g., of a folding device, information that, for example, a synchronizing signature is needed in order to synchronize the folding device with the new order, information that a white signature is needed in order to give the (digital) printing facility time to set up the new print order, information that with the offset printing facility a folding device is integrated as well as their particularities, folding possibilities, requirements in terms of the respective required or permissible product sizes, etc.

The objective of the present invention thus is to rectify the abovementioned disadvantages of a manual configuration of the respective order data. This is solved by a production planning and control system of a printing facility and by a method for the automated generation of a print order according to the invention.

The production planning and control system is characterized in that an imposition module is present which can receive and has stored all information and data that is available for the printing facility in a centralized manner and based on these data can generate a complete description, i.e., a production data set for the order to be printed. Thus, the production data sets include both the imposition layout or pattern as well as all other previously mentioned data such as, for example, required synchronization or white signatures, etc. The method is characterized in that a complete print order is generated which automatically includes all data that is available for the printing facility in generating a production data set. Accordingly, a complete and unambiguous description of a print order, i.e., of a production data set, can be easily generated without human intervention so that further automation of the printing facility and a system that is less susceptible to error can be made available.

In the following, the invention is explained in more detail with the help of the attached drawings, which merely represent exemplary embodiments.

### BRIEF DESCRIPTION OF THE DRAWINGS

FIG. 1 is a representation of the production planning and control system for the automatic generation of a production data set according to a first embodiment of the present invention;

FIG. 2 is a representation of the production planning and control system for the automatic generation of a production data set according to a second embodiment of the present invention; and

FIG. 3 is a representation of the production planning and control system for the automatic generation of a production data set according to a third embodiment of the present invention.

### DETAILED DESCRIPTION OF THE DRAWINGS

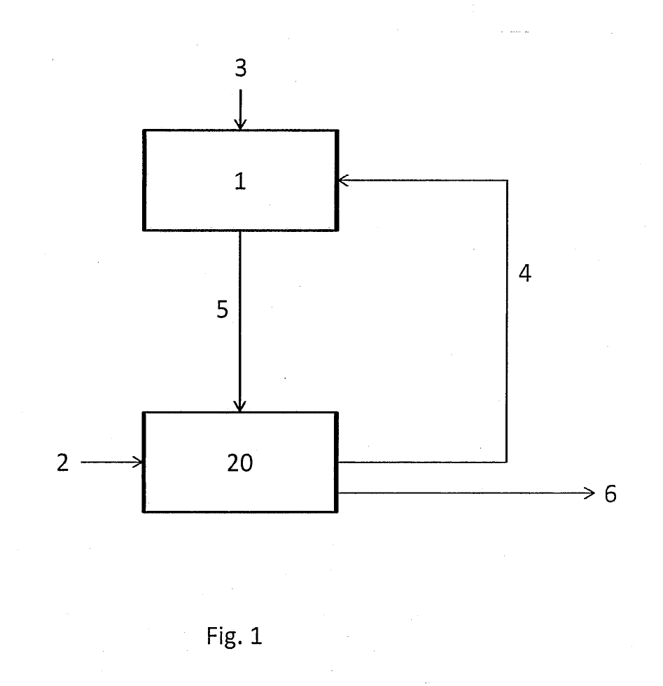

With respect to FIG. 1, a first embodiment of the present invention is shown and described which includes an automatic generation of a production data set 5, i.e., of a complete data set of a print order, by the imposition module 1, where the printing facility 2 includes only a single printing press 20, in this case an offset printing press. For generating a production data set 5, which makes possible generating a complete print order, the job data 3 of the order to be printed and the production possibilities 4 of the offset printing press 20 mentioned as an example here, are submitted to the imposition module 1. Here, the production possibilities 4 include, for example, the configuration of the non-print form variable printing press, such as, for example, an offset printing press, information as to whether the exemplarily mentioned offset printing press includes an integrated further processing device or, for example, which colors it is able to print, which web width is possible, etc. These data are centrally combined in the imposition module 1 together with additionally available data, which are needed for generating the print order, processed there and a complete print order in the form of a production data set 5 is generated, which is passed on to the printing facility 2 for processing.

FIG. 1 can obviously be applied also to a print form variable printing press such as, for example, a digital printing press, where in this case in addition to the general parameters, personalization data can also be incorporated in the production data set.

Not shown, however also covered by the invention, is the version in which the printing facility consists of the combination of at least one non-print form variable printing press and at least one print form variable printing press, as is employed, for example, with packaging printing presses, where sometimes multiple non-print form variable printing methods such as, for example, the offset printing method, the intaglio printing method, the relief printing method or flexographic printing method or the screen printing method are combined with multiple print form variable printing methods such as, for example, the inkjet method, toner-based digital printing methods, etc.

By processing all data needed for a print order in a central device, the imposition module 1, a production data set 5 can be generated which renders intervention by a human operator obsolete for completing the print order, i.e., a completely automated method is made available.

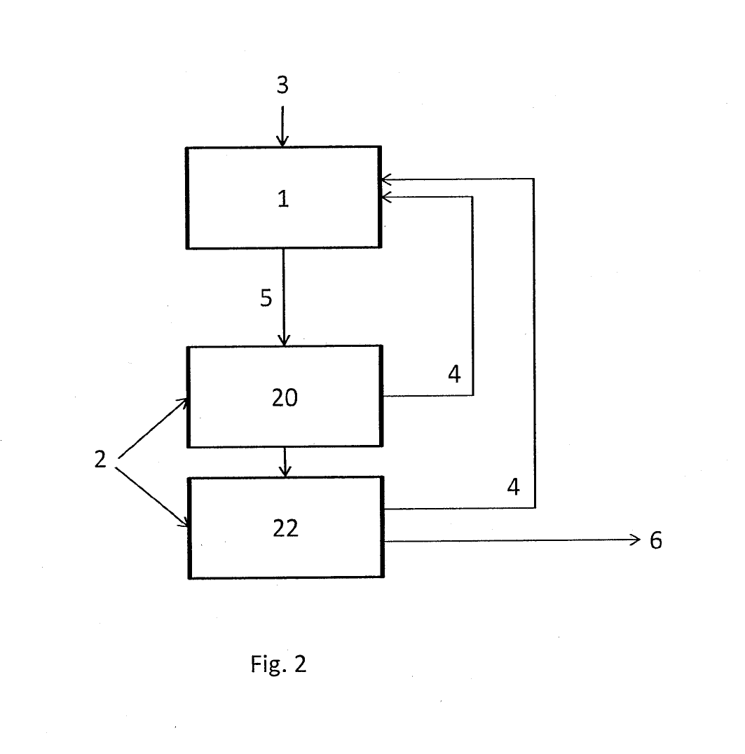

Shown and described with reference to FIG. 2 is a second embodiment of the present invention which includes automatic generation of a production data set 5 by the imposition module 1, where the printing facility 2 includes a printing press 20, in this case a digital printing press, and a further processing device 22 located downstream of the printing press, in this case, for example, a combined cutting and folding device.

However, all devices for further processing or refining the print product such as, for example, a cutting device, folding devices, combined cutting and folding devices, collecting or stitching devices, devices for perforating, punching, gluing, coating, foil transfer and much more arranged downstream of the printing process are considered as a further processing device 22. In the process, a combination of multiple same or different aforementioned further processing devices 22 can be employed.

The individual components of a printing facility 2 such as, for example, non-print form variable or print form variable printing presses 20 or further processing devices 22 are generally also described as processing devices.

Generating a production data set 5 takes place as in the first exemplary embodiment merely with the difference that the printing facility 2 in this case consists of two devices that are separate from one another, the digital printing press 20 and the further processing device 22. Accordingly, production possibilities 4 of the two devices are separately submitted to the imposition module 1, stored there and processed in conjunction with the job data 3 of the order to be printed into a production data set 5 which is then passed onto the printing press 20 for processing. The printing press 20 can then print the order according to the imposition layout submitted to it or, for example, print needed personalization data passing these on directly to the further processing device 22 since the production data set 5 has also taken into account the production possibilities 4 of the further processing device 22 during the generation of the production data set 5. Accordingly, no further calculation by a separate module or other intervention, for example by a human, is needed up to the completion of the print product 6. Consequently, the automation of the printing facility 2 is significantly increased and the error probability through external intervention significantly lowered.

However, the invention also includes the embodiment in which the printing facility 2 shown in FIG. 2 consists of a non-print form variable printing press 20 and a further processing device 22 connected downstream. Generating a production data set is carried out in the same manner but no personalization data can be taken into account in this embodiment.

A preferential configuration of the printing facility 2 is the one in which at least one non-print form variable printing press 20 with at least one, i.e., if appropriate also multiple, re-processing devices 22 connected or arranged one after the other is employed, as is the case, for example, in non-print form variable packaging printing presses, in which sometimes multiple printing methods are utilized.

A further advantageous configuration of the invention likewise not shown in FIG. 2 is the one in which a production data set 5 for a printing facility 2 is generated, which consists of at least one print form variable printing press 20 with at least one, i.e., if appropriate also multiple, re-processing devices 22 connected or arranged one behind the other. Such a configuration can be employed, for example, in print form variable systems with refinement or print form variable printing of higher and lower quality features.

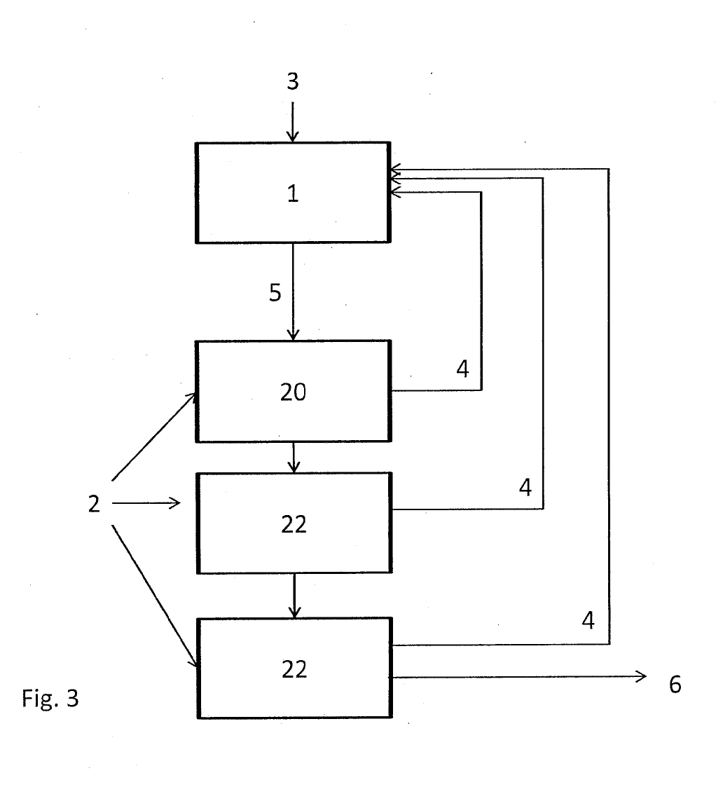

Shown and described with reference to FIG. 3 is a third embodiment of the present invention, which includes automatic generation of a production data set 5 by the imposition module 1 where, as printing facility 2, a hybrid system is available, which in this example consists of a non-print form variable printing press 20 such as, for example, an offset printing press and a print form variable printing press 20 located downstream of the non-print form variable printing press 20 such as, for example, a digital printing press with further processing device 22 located downstream. In this exemplary embodiment, a first part of a print order is printed in the non-print form variable printing press 20, the intermediate product created is then finish-printed in the print form variable printing press 20, e.g., furnished with a personalization, and finally processed into the finished product in the further processing device 22, for example, by cutting and folding.

A further extremely advantageous configuration of the invention, which however is not shown in FIG. 3, is the one in which a production data set 5 for a printing facility 2 is generated which consists of at least one non-print form variable printing press 20, of at least one print form variable printing press 20, and of at least one re-processing device 22. Such configurations are relevant, for example, for the packaging print, during which multiple non-print form variable printing methods are combined with at least one print form variable method with sometimes complex re-processing machinery.

In principle, generating the production data set 5 takes place as in the preceding examples but only more complex calculations for generating the production data set 5 are needed. For in the imposition module 1 the job data 3 of the order to be printed are interlinked with the production possibilities 4 of the devices that exist in the printing unit 2, i.e., the production possibilities 4 of the non-print form variable printing press 20, of the print form variable printing press 20, and the further processing device 22, when generating the production data set 5 so that based on these data a production data set 5 can be generated, with which without further changing or adding of data or information regarding processing, the desired product can be checked regarding realizability or produced according to the print order. Here, complex processing of data of the individual machines is thus carried out by way of which a production data set 5 for this hybrid method is generated.

A further embodiment of the present invention not shown in the Figures includes generating the production data set 5 based on an already partly completed print order, i.e., existing additional information, the job data 3 and the production possibilities 4 of the devices present in the printing facility 2.

In this exemplary embodiment, similar to the hybrid printing methods, all production possibilities 4 of the devices needed for carrying out the print order are submitted to the imposition module 1. In addition, the data of an already partly completed print order are submitted to the imposition module 1 as further input variables so that for completing the print order 6 a suitable production data set 5 can be generated.

Preferably, the generation of the production data set 5 depends on the device that has the least flexibility for processing and/or the most restrictive specifications or restrictions, i.e., is the “weakest” link in the production chain. Based on the specifications of this “weakest” link, the production possibilities 4 of the other devices are then suitably scanned in order to generate the suitable production data set 5 that completely describes the print order so that automatic processing up to the end product can take place.

The examples provided above show that the imposition module 1 can automatically generate a production data set 5 for any configuration of the printing unit 2. The imposition module 1 can be integrated in a print line, however is also suitable for retrofitting at least one already existing printing facility 2. Furthermore, the control is not dependent on the manufacturer of the individual processing devices.

Outputting the print order or the production data set 5 can be effected by an xml-file or another computer-readable file. At any rate, a format for outputting corresponding to the processing devices used can be selected.

The method for automatically generating a complete print order according to the present invention is illustrated by the FIGS. 1, 2 and 3 and described in the following. In a first step, an order to be printed is submitted to the production planning and control system, more precisely to the imposition module 1, from which the job data 3 are generated. In addition, of the processing devices that are present in the printing facility 2, such as at least one non-print form variable printing press 20 such as, for example, an offset printing press, at least one print form variable printing press 20, such as, for example, a digital printing press and a further processing device 22, such as, for example, a cutting/folding device according to the third exemplary embodiment, the respective production possibilities 4 are submitted to the imposition module 1 or are already available therein. Based on the existing or submitted data and information, the imposition module 1 calculates data for a production data set 5, generates this production data set 5 and optionally finally submits the production data set 5, i.e., the data set of the complete print order, to the first processing device in the printing unit 2. Taking into account all known data and information, the production data set 5 is generated so that the same does not require any further modification from the first processing device to the last processing device. Accordingly, a new type and fully automated method for producing a print product 6 is made available.

The invention makes it possible to control printing facilities 2 of any complexity so that a completely described print order is submitted to the first processing unit of the printing facility 2, in which all steps and devices to be subsequently carried out have been taken into account so that a greatly increased degree of automation of the printing facility 2 can be achieved. The production possibilities 4 of the individual devices of the printing facility 2 can either be known by the type of device itself, i.e., by the specifications provided by the manufacturer, or directly measured by interfaces, software, sensors or other measurement equipment and submitted to the imposition module 1 in this way.

### LIST OF REFERENCE NUMBERS

1 Imposition module

2 Printing facility

20 Printing press

22 Further processing device

3 Job data

4 Production possibilities

5 Production data set

6 Print product

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A production planning and control system of a printing facility, comprising:
an imposition module, wherein job data of an order to be printed and production possibilities of at least one processing device of the printing facility are receivable at the imposition module and wherein a production data set for the order to be printed is automatically generatable by the imposition module based on the job data and the production possibilities.

2. The production planning and control system according to claim 1, wherein a first processing device is a printing press.

3. The production planning and control system according to claim 2, wherein the printing press is a print form variable printing press and/or a non-print form variable printing press.

4. The production planning and control system according to claim 2, wherein a second processing device is a device for further processing or refining a print product printed by the printing press.

5. The production planning and control system according to claim 4, wherein the second processing device is a cutting device or a folding device or a combined cutting and folding device or a collecting device or a stitching device or a device for perforating or a device for punching or a device for gluing or a device for coating or a device for foil transfer.

6. The production planning and control system according to claim 1, wherein the job data includes information as to whether the order has already been subjected to pre-processing.

7. The production planning and control system according to claim 1, wherein the production data set is providable to the printing facility for processing.

8. A method for generating of a production data set for an order to be printed in a printing facility, comprising the steps of:
receiving job data for the order to be printed and production possibilities of at least one processing device of the printing facility at an imposition module; and
automatically generating the production data set by the imposition module based on the job data and the production possibilities.

9. The method according to claim 8, wherein the production data set includes an imposition pattern generated for the order and information required for processing.

10. The method according to claim 9, wherein the information required for processing is synchronization signatures or white signatures for separating successive orders.

11. The method according to claim 8, wherein a first processing device is a printing press.

12. The method according to claim 11, wherein the printing press is a print form variable printing press and/or a non-print form variable printing press.

13. The method according to claim 11, wherein a second processing device is a device for further processing or refining a print product printed by the printing press.

14. The method according to claim 13, wherein the second processing device is a cutting device or a folding device or a combined cutting and folding device or a collecting device or a stitching device or a device for perforating or a device for punching or a device for gluing or a device for coating or a device for foil transfer.

15. The method according to claim 8, wherein the job data includes information as to whether the order has already been subjected to pre-processing.

16. The method according to claim 8, further comprising the step of providing the production data set to the printing facility for processing.
